(19) United States
(12) Patent Application Publication
(10) Pub. No.: US 2014/0310755 A1
(43) Pub. Date: Oct. 16, 2014

(54) CONFIGURATION DATA TRANSMISSION SYSTEM USING COAXIAL AND/OR FIBRE OPTIC DISTRIBUTION NETWORK

(71) Applicant: GLOBAL INVACOM LTD., Stevenage, Hertfordshire (GB)

(72) Inventor: Gary Stafford, Stevenage (GB)

(21) Appl. No.: 14/363,516

(22) PCT Filed: Dec. 6, 2012
(86) PCT No.: PCT/GB2012/053034

§ 371 Date: Jun. 6, 2014

(30) Foreign Application Priority Data
Dec. 6, 2011 (GB) 1120894.9

(51) Int. Cl. H04N 21/6373; H04N 21/61

(52) U.S. Cl. CPC H04N 21/6373; H04N 21/6156
USPC 725/81

(57) ABSTRACT

A rate adaptation mechanism to allow optimisation of the transmission of video and/or data streams and, in particular, multiple high definition video streams. The invention allows for the efficient transmission of the data through a system using coaxial and/or fibre optic communication means.

The invention which is the subject of this application relates to a rate adaptation mechanism to optimise the transmission of video data streams and, in particular, multiple high definition video streams. Particularly, although not necessarily exclusively, the invention relates to the efficient transmission of the data through a system using coaxial and/or fibre optic communication means.

It is known to provide for the wireless streaming of video in a building such as a domestic premises. Typically there will be provided a plurality of different apparatus within the premises including, for example, a broadcast data receiver (also referred to as a sep top box), a DVD player, a display screen and speakers which are interconnected and which are, at present, typically the most commonly used apparatus in a premises and located, for example, in the lounge. A High Definition Data (HDTV) transmitter can also be provided to stream video and audio to a range of wireless video receivers located in other parts of the premises and thereby allow video and audio feeds to be available for connection to apparatus at those locations.

Methods for designing and utilising a system with a transmitter which is used to send a single video stream to a single receiver are relatively well understood and, in the simplest implementation, the total of the video bitrate plus the audio bitrate should not exceed the capacity of the wireless channel used to carry the data.

While the rest of this document refers to video bitrate for brevity as the audio bitrate is small compared to video bitrate, reference hereonin to video bitrate should be interpreted as including any audio bitrate which is present at that time. Also, if required, the invention can be utilised for the transmission of audio only.

Adaptation of the video bitrate occurs dynamically and operates using a rate distortion model which takes into account information relating to the content type being transmitted, an assessment of the error impact on the transmitted data and/or resilience features which are implemented within the Video-Adaptive Modulation and Coding Scheme (MCS). The rate distortion model then uses this information to determine the overall video quality benefits of switching from the current MCS mode to another adjacent MCS mode.

The principle objective of the present invention is to utilise rate adaptation in transmission systems in which multiple video streams are required to be transmitted via coaxial and/or fibre optic transmission means.

According to a first aspect of the invention there is provided a method of controlling and transmitting data transfer in a video system which includes one or more video data sources, a transmitter operable to transmit video data from the one or more video data sources using transmission channels, a plurality of receiver locations operable to receive transmitted video data via the respective transmission channels, wherein the method determines a bitrate for the transmission of the data by the steps of;
estimating available channel capacity for the receiver locations using parameters relating to the transmission channel concerned and/or information available at the transmitter and/or receiver and/or information relating to queuing of video data between the video data sources and the transmitter;
determining a target transmit bitrate for the data to the receiver location in dependence upon the estimated channel capacity , and/or a quality parameter, and/or an activity parameter for the receiver location concerned; and
controlling the video data sources and transmitter in dependence upon the determined transmit bitrates.

Typically the channel capacity estimate and target transmit bitrate is calculated for each of the client receivers.

Typically the estimate of the available channel capacity is made using parameters relating to the transmission channel concerned, and information available at the transmitter and receiver, and information relating to queuing of video data between the video data sources and the transmitter.

Typically the target transmit bitrate is determined for each of the receiver locations in dependence upon the estimated channel capacity, a quality parameter, and an activity parameter for the receiver location concerned.

The determining of the target transmit bitrate for each receiver location using this method enables the optimization of transmission of data to each receiver location over a single channel.

Preferably the quality parameter for a receiver location relates to respective picture quality for each of the receiver locations. The quality expectation for each receiver location will be receiver location dependent and impact upon the target transmit bitrate for that receiver location.

Information available at the transmitter and receiver locations such as modulation and coding scheme, packet error rate (PER), number of automatic repeat requests (ARQs) and received signal strength (RSSI) may also be used in determining the target transmit bitrate for a receiver location, the information being related to the receiver location concerned.

In one embodiment of the invention, a rate-distortion model is used in determining the target transmit bitrates, and typically the rate-distortion model relates to all of the receiver locations.

Typically the data is carried from the transmitter to the receiver locations via a communication system using a coaxial and/or fibre optic cabling network.

The implementation of the method of controlling data transfer in the method of transmitting video data enables the optimization of transmission of video data to each of a plurality of receiver locations connected via the cabling network provided.

According to a further aspect of the invention there is provided a multi-channel data control and transmission system comprising a plurality of video sources operable to output respective video data streams; a transmitter operable to receive video data streams from the video sources, and operable to transmit such video data streams over transmission channels; a plurality of receiver locations operable to receive the video data streams over respective transmission channels from the transmitter; wherein there is provided a transmit controller operable to estimate available channel capacity for each receiver location using parameters relating to the channel concerned and/or using information available at the transmitter, and/or using information relating to the queuing of video data between the video data sources and the transmitter, to determine a target transmit bitrate for each receiver location in dependence upon estimated channel capacity and/or a quality parameter and/or an activity parameter for the receiver location and to control the video data sources and transmitter in dependence upon determined transmit bitrates.

The inclusion of a transmit controller in the multi channel system enables dynamic optimization of the transmit bitrates employed by the video sources for the transmission of the data streams across the available channel.

Preferably the quality parameter for a receiver location relates to respective picture quality for each of the receiver locations.

The transmit controller may be operable to use information available at the transmitter and receiver such as modulation and coding scheme (MCS) mode, packet error rate (PER), number of automatic repeat requests (ARQs) and received signal strength (RSSI) in determining the target transmit bitrate for a receiver location. Typically the information is related to the receiver location concerned. The transmit controller may further be operable to use a rate-distortion model in determining the target bit transmit rates. Typically the rate distortion model relates to all of the receiver locations.

The use of these features by the transmit controller facilitates optimization of the target bit transmit rates to best suit each receiver location requirement.

According to a further aspect of the invention there is provided a method of transmitting multimedia data from a transmitter to a plurality of receiver locations, the method comprising: receiving a first data stream comprising multimedia data and control data; extracting the control data from the first data stream to produce a multimedia data stream and a control data stream; transmitting the multimedia data stream to one or more receiver locations over a first channel and transmitting the control data stream to the one or more receiver locations over a second channel wherein the first channel is an in-band channel, and the second channel is an out-of-band channel.

The transmission of control data using a different channel from that used for multimedia data transmission enables optimisation of bandwidth use whilst maintaining quality of transmitted data.

The receiving of control data on a second channel, different from the first channel for the receiving of multimedia data enables minimisation of reception of unnecessarily repeated control data thus optimising bandwidth usage for the transmission of multimedia data. The second channel may be a session announcement protocol channel.

Conveniently the control data stream includes transport stream data items which may include data items relating to one or more of program specific information, program association table information, program map table information, conditional access table information and network information table information.

These transport stream data items will change infrequently therefore by inclusion in the control data stream will minimise transmission of unnecessarily duplicated data.

Conveniently, the control data stream includes codec configuration data items which may relate to one or more of encoder settings information, sequence parameter sets information and picture parameter sets information. The codec configuration data will change infrequently therefore by inclusion in the control data stream will minimise transmission of unnecessarily duplicated data.

According to a yet further aspect of the invention there is provided apparatus for transmitting multimedia data to one or more receiver locations, the apparatus comprising an input unit operable to receive a first data stream comprising multimedia data items and control data items; an extraction unit operable to extract control data items from a first data stream to produce a multimedia data stream and a control data stream; a transmitter operable to transmit a multimedia data stream to a receiver location over a first channel, and to transmit a control data stream to that receiver location over a second channel different to the first channel, wherein the first channel is an in-band channel, and the second channel is an out-of-band channel.

Apparatus which enables transmission of control data using a different channel from that used for multimedia data transmission enables optimisation of bandwidth use whilst maintaining quality of transmitted data.

The provision of apparatus which receives control data on a second channel, different from the first channel for the receiving of multimedia data enables minimisation of reception of unnecessarily repeated control data thus optimising bandwidth usage for the transmission of multimedia data. The second channel may be a session announcement protocol channel.

Conveniently, the control data stream includes transport stream data items which may include data items relating to one or more of program specific information, program association table information, program map table information, conditional access table information and network information table information.

The control data stream may include codec configuration data items which may relate to one or more of encoder settings information, sequence parameter sets information and picture parameter sets information.

In whichever embodiment the apparatus and system implemented with respect to the same are connected via fibre optic and/or coaxial cable network system to allow the distribution of the data and service to different locations within a single premises or series of premises, typically from a common source.

These and other aspects of the present invention will be more clearly understood from the following description and, by way of example only with reference to the accompanying Figures; wherein

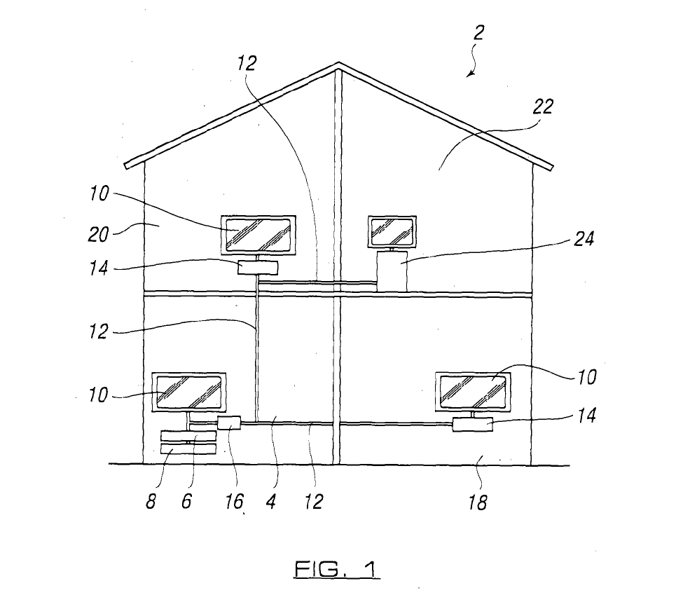

FIG. 1 illustrates a first embodiment of a premises utilising a system in accordance with one embodiment of the invention; and

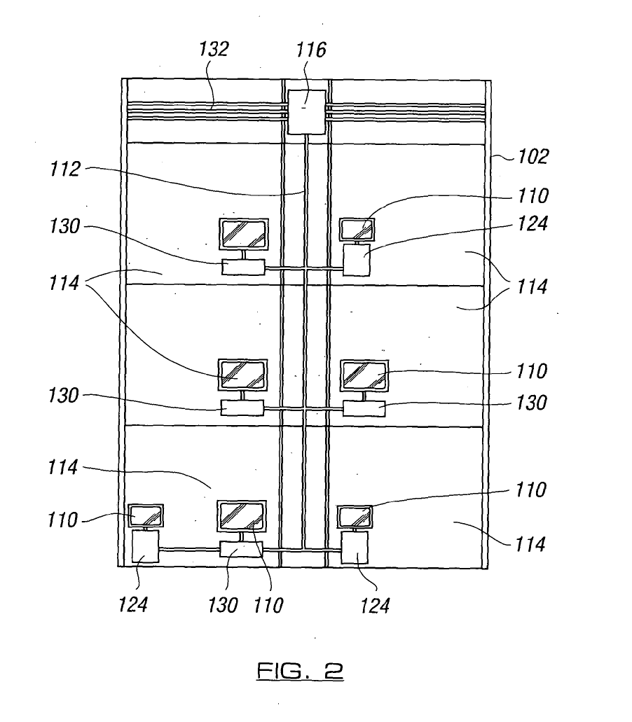

FIG. 2 illustrates a second embodiment of a premises utilising a system in accordance with a first embodiment of the invention.

In the implementation example shown in FIG. 1 there is provided a video and audio transmission system implemented in a building 2 in the form of a domestic premises and the invention allows the streaming of video in the building. In one room 4 there can be provided a receiver in the form of a set-top box 6 and DVD player, such as a Blu-Ray player 8 which are connected to the television 10. The set-top box 6 and Blu-ray player 8 also feed an HDTV transmitter 16, which streams video and audio to apparatus in other rooms such that, for example, cables 12 connect, in two rooms 18,20, video data receivers or encoders 14, each of which are connected to high definition televisions 10. In a further room 22, the video is received by a PC 24. The transmission system further comprises multiple client receivers 6, 14, 24, each including a video decoder which is in turn connected to a corresponding display device such as a high definition TV 10.

In another form of the invention shown in FIG. 2 the invention is implemented in a premises 102 in the form of a Multi Dweller unit or apartment block in which there are provided a series of independent receiver locations 114 formed by each of the independent apartments. In this case each of the apartments includes a receiver location including an encoder or set top box 130 or PC 124 which is connected to a display screen 110 and/or further receiver 130 and/or PC 124 and which receives data from connected coaxial or fibre optic cables 112 which form a distribution network through the premises and which cables lead from a server which includes a transmitter 116 which receives a plurality of video and audio data feeds 132.

In both embodiments the cables 12, 112 of the network allow the distribution of the video and audio data to the receiving locations at the bitrates which are calculated in accordance with this invention. It should also be appreciated that in a yet further embodiment, rather than the receiver locations be provided in the same building premises, each of the receiving locations is be a different building or premises at spaced geographical locations in, for example, a housing estate. In each case, the transmission system at a location has multiple video encoders or transcoders sharing a single transmitter.

Each video encoder is provided with a corresponding input video signal which may be the same or be a specific input for that particular receiver at that location. The multiple video streams which are output from the video encoders, will be transmitted over a single channel from the transmitter 16 and the transmission system is further provided with a transmit controller (not shown), but which is typically a link adaptor, which is in communication with the video encoders; transmitter and, optionally, the receivers. Within the link adaptor there is provided a video stream rate adaptation mechanism. During use, each video encoder compresses the received individual input video signal at a target bit rate of kᵢ bits per second. The target bit rate for the corresponding encoders is determined by the link adaptor to optimize the bit allocation rate for each of the video streams which are to be carried on the transmission channel.

The rate adaptation mechanism operates within the link adaptor via a series of steps to implement the optimization of the bitrate allocation and data transfer.

First, the rate adaptation mechanism generates an estimate of the channel capacity for each receiver location. In this case, the rate adaption mechanism receives parameters obtained from the transmitter and, optionally, receivers including, but not limited to MCS mode, packet error rate (PER), number of automatic repeat requests (ARQs), and received signal strength indication (RSSI) and uses these parameters to obtain estimates of the channel capacity for each receiving location. In this case, the rate adaptation mechanism may optionally use measurements obtained from the receivers using packet dispersion whereby the transmitter transmits a number of data packets, back to back and estimates the channel capacity based on the relative delay between the reception of the packets at the chosen receiver. The rate adaptation mechanism may further utilise data provided by monitoring the buffer occupancies at the outputs of the encoders and the input to the radio transmitter.

It will be understood that the rate adaption mechanism may alternatively employ any one or any combination of the received parameters, the packet dispersion measurement and/or the buffer occupancy data to generate the channel capacity estimates. The estimated channel capacity Cᵢ for each receiver represents the available channel throughput for each receiver if it were to utilise 100% of the available channel capacity.

The rate adaptation mechanism then establishes the relative video quality expectations at the output of each receiver video decoder. The quality differentials, can be, in this case, specified by the user of each display device 10 and take into account factors such as, for example, differences in the expectations of resolution and clarity required by a user of a large LCD TV as opposed to those expected for a small TV or a PC monitor

The rate adaptation mechanism then establishes the complexity of the content being encoded by each encoder whereby factors such as the motion level and/or type and level of texture detail of the content, and quantization parameter (QP) values used by the encoder, are relevant to the target bit rate for any given quality.

Alternatively, the quality differentials could be determined, or modified, automatically by a set of rules which can, for example, be embodied in the software of the system. In one example, the resolution of the video fed to each receiver location encoder, and the resolution of each display device connected thereto could be used to calculate automatically the quality differential. In another example, it may be desirable to allocate equal channel time utilization to all the receiver locations. This could be beneficial in the case where there is a relatively remote receiver location which requires a very robust modulation mode to be used to ensure adequate data reaches the receiver location to allow the service to be provided, but which robust modulation mode is disproportionately costly in transmission time. In this case, the remote receiver location receives the video and/or audio data at a lower bit rate than that which is used to transmit the data to nearer receiver locations, at the expense of quality, in order to preserve the quality of the service provided at those receiver locations which are closer to the encoder.

A quality weighting, Qᵢ, is generated by the rate adaptation mechanism for each receiver location using the quality expectation data. In a relatively simple case, the quality may be assumed to be equal for each receiver and directly proportional to the bit rate, with:

$${Q}_{i} = \frac{1}{N}$$

In all cases: ΣQᵢ=1

The rate adaptation mechanism also dynamically generates an activity weighting, Aᵢ, which reflects the relative demands of the content of each input video stream from its respective encoder. In one example, the activity weighting is generated at the same time as the content complexity rating, meaning that these steps are effectively combined. In another example, the steps are separated.

In either case, the activity weighting is generated based on parameters related to content complexity such as motion complexity, texture detail, QP values, etc. Frame statistics, including motion vector and texture variance, are used to provide the input data for the activity weighting. It will be understood that whilst, in this case, the activity weighting is based on frame statistics, it could similarly be generated based on group of pictures (GOP) level second order statistics including motion vector and texture variance.

Having generated channel capacity, quality weighting and activity weighting for each encoder-receiver location pair, the rate adaptation mechanism then generates the target bit rate for each encoder-receiver location pair as follows:

$${\sum }_{i} \frac{{A}_{i} {Q}_{i} R}{{C}_{i}} = 1$$

$$where R = \frac{1}{{\sum }_{j} \frac{{A}_{j} {A}_{j}}{{C}_{j}}}$$

It will be understood that in some cases, in order to provide an overhead or tolerance within the calculation of the target bit rate, to take into account local bit rate deviations, a summation total which is less than unity is assigned. The target bit rate is then fed back to the encoder and the incoming video stream is encoded at this rate for transmission.

In a further embodiment of the rate adaptation mechanism the mechanism is further provided with a rate distortion mechanism for each receiver location. The rate distortion mechanism establishes the rate distortion (RD) performance for each receiver location in the system. The rate distortion mechanism uses data including content type and the effects of error propagation and concealment at each receiver location. The rate adaptation mechanism then generates the target bit rate for each receiver location using the generated channel capacity, quality weighting and activity weighting along with the RD performance established by the rate distortion mechanism as follows:

$${\sum }_{i} {RD}_{i} ( \frac{{A}_{i} {Q}_{i} R}{{C}_{i}} ) = 1$$

The established RD performance may be further used by the link adapter to facilitate optimum and adaptive selection of parameters within transmitter and encoders, such as MCS mode switching, quantiser selection and the addition of redundancy to ensure optimum end to end performance, based on video quality rather than throughput alone. For example, for each client receiver, an RD model is applied and a decision made whether to change MCS mode to achieve improved video quality. In use, if there is no difference in content activity in each video stream, and no difference in quality expectations between displays, the target bit rate determined by the link adapter will be identical for each encoder.

However, when receiver locations have different quality requirements and video streams have variations in content type, the rate adaption mechanism will account for these and thus the target bit rates applied to encoders will vary accordingly. In addition, as individual receiver locations experience different channel conditions to one another, for example, due to different MCS modes, different automatic repeat request (ARQ) rates or different packet error rates (PER) this will be taken into account by the rate adaptation mechanism and modification of the bit allocation generated by the link adaptor for implementation on these channels.

In a further example the network again comprises at least one transmitter and a plurality of receiver locations each provided with at least one video decoder.

A server is provided with an in-band transmitter and out-of band transmitter and includes media encoders, transport Stream Multiplexers (TS Mux), which in this case are MPEG2 TS Mux, and server data transmission mechanism. Within the server data transmission mechanism there is provided an extraction mechanism and data format mechanism.

The server receives multiple input media streams, with each media stream provided to an audio encoder and a video encoder respectively. The data output from encoders is input to corresponding MPEG2 TS Mux respectively. Each MPEG2 TS Mux combines the data from the multiple encoders into corresponding multiplexed MREG2 TS data streams which are input to corresponding extraction mechanisms within server data transmission mechanism. Each extraction mechanism parses the generated transport stream and removes both the transport stream and codec configuration data which are provided as a data stream to data format mechanism wherein the transport stream and codec configuration data are packetized and suitably formatted for provision to out-of band transmitter for transmission as an out-of-band configuration data stream. The multimedia data stream output from extraction mechanism is provided to in-band transmitter for transmission in-band as an in-band media data stream. The network over which server transmits may be reliable or unreliable.

A receiver location may be any one of a number of receiving locations of the type shown in FIG. 2. The receiving location is provided with an in-band receiver and an out-of-band receiver. The receiving location comprises client data transmission mechanism, Transport Stream Demultiplexer (TS Demux) and an audio decoder and a video decoder. The client data transmission mechanism comprises a data format mechanism and an insertion mechanism. The receiving location receives both the in-band media data transport stream and the out-of-band transport stream and codec configuration data from in-band receiver and out-of-band receiver respectively. The out-of band configuration data is provided to data format mechanism where the out-of-band configuration data are formatted into the original transport stream and codec data form. The insertion mechanism receives the transport stream and codec configuration data from the data format mechanism and also receives media data transport stream from the in-band receiver. The insertion mechanism re-inserts the transport stream and codec configuration data into transport stream. The output data of the client data transmission mechanism are functionally identical data stream to that going into the server data transmission mechanism. This consistency of data ensures that generic standards compliant codec can be used. The data stream is then provided to TS Demux which in this case is a MPEG2 TS Demux which demultiplexes the data stream before providing it to decoders for decoding and provision to a display device (not shown).

As transport stream configuration data and codec configuration data extracted by extraction mechanism change relatively infrequently for any given video and audio stream, bandwidth within the network can be preserved for transmission of the transport stream data by sending the configuration data, at an appropriate frequency, out-of-band. The preserved bandwidth can then be optimised to maintain quality of service in the provision of the video and audio stream.

In a further embodiment the server is provided a transmitter suitable for transmission over an unreliable network. The server comprises encoders, in this case media encoders, Transport Stream Multiplexers (TS Mux) which in this case are MPEG2 TS Mux, and server data transmission mechanism. Within the server data transmission mechanism there is provided extraction mechanism and an announcement generator mechanism. The announcement generator mechanism is in this case a Session Announcement Protocol announcement generator mechanism.

The server in this case, receives multiple input media streams with each media stream provided to an audio encoder and a video encoder respectively. The data output from encoders is input to a corresponding MPEG2 TS Mux respectively. Each MPEG2 TS Mux combines the data from the multiple encoders into corresponding multiplexed MREG2 TS data streams which are input into corresponding extraction mechanism within server data transmission mechanism. Each extraction mechanism parses the multiplexed stream and removes both the transport stream and codec configuration data which is provided as a data stream to announcement generator mechanism wherein the transport stream and codec configuration data is packetized and suitably formatted and with identifiers for the available transport streams to form an announcement message data stream for provision to transmitter for transmission over an unreliable network. The multimedia data transport streams output from extraction mechanisms are also provided to transmitter for transmission over an unreliable network. Announcement messages are sent by transmitter at predetermined bit rate allocated for sending announcement messages which is known as an announcement interval.

A receiving location is operable to receive transmissions from the server transmitter. The receiver location is provided with a receiver for receiving transmissions from server transmitted over the unreliable network. The receiver location comprises client data transmission mechanism, Transport Stream Demultiplexer (TS Demux), audio decoders and video decoder. The client data transmission mechanism comprises an announcement receiver mechanism, a stream selector mechanism and an insertion mechanism. The announcement receiver mechanism is, in this case, an SAP Announcement receiver mechanism.

In use, the receiver location receives the data transmitted over an unreliable network at the receiver. The receiver listens for announcement messages. The configuration data and identifiers for the available streams are included in the announcement messages which are received and forwarded to announcement receiver. Upon successfully receiving the announcement message announcement the receiver extracts the configuration data which is formatted appropriately and provided to the insertion mechanism. The announcement receiver also extracts the identifiers for the available transport streams and provides this data to stream selector mechanism. The stream selector mechanism selects the required transport stream and provides this to insertion mechanism. The insertion mechanism re-inserts the transport stream and codec configuration data into appropriate transport stream. The output data of the client data transmission mechanism is a functionally identical data stream to that going into the server data transmission mechanism. This consistency of data ensures that generic standards compliant codec can be used. The data stream is then provided to TS Demux which in this case is a MPEG2 TS Demux which demultiplexes the data stream before providing it to decoders for decoding and provision to a display device.

As the receiver location must receive the announcement messages in order to know what data streams are available and successful reception of an announcement message means that the receiver location has also received the parameter information within the configuration data which provides the transmission mechanism with a pseudo-reliable characteristic of delivering the configuration data.

The inclusion of the configuration data within an out-of-band stream broadcast service, such as in this example, Session Announcement Protocol (SAP) within a multicast environment simultaneously provides the client with available transport data and the corresponding transport stream and codec configuration data required to deliver each transport data stream efficiently.

As transport stream configuration data and codec configuration data extracted by extraction mechanism change relatively infrequently for any given video and audio stream, bandwidth within the network can be preserved for transmission of the transport stream data by sending the configuration data, at an appropriate frequency, out-of-band. The preserved bandwidth can then be optimised to maintain quality of service in the provision of the video and audio stream.

1. A method of controlling and transmitting data transfer in a video system which includes one or more video data sources, a transmitter operable to transmit video data from the one or more video data sources using transmission channels, a plurality of receiver locations operable to receive transmitted video data via the respective transmission channels, wherein the method determines a bitrate for the transmission of the data by the following steps of:
estimating available channel capacity for the plurality of receiver locations using parameters relating to members of the group consisting of the transmission channel concerned, information available at the transmitter, information available at the receiver, information relating to queuing of video data between the video data sources and the transmitter;
determining a target transmit bitrate for the data to the receiver location in dependence upon members of the group consisting of the estimated channel capacity, a quality parameter, or an activity parameter for the receiver location concerned; and
controlling the video data sources and transmitter in dependence upon the determined transmit bitrates.

2. A method according to claim 1 wherein the channel capacity estimate and target transmit bitrate are calculated for each of the receiver locations independently.

3. A method according to claim 1 wherein forming the channel capacity estimates uses parameters relating to members of the group consisting of the transmission channel concerned, information available at the transmitter and receiver location, and information relating to queuing of video data between the video data sources and the transmitter.

4. A method according to claim 1 wherein the target transmit bitrate is determined for each of the plurality of receiver locations in dependence upon members of the group consisting of the estimated channel capacity, a quality parameter, and an activity parameter for the receiver location concerned.

5. A method according to claim 4 wherein provision of a value of the target transmit bitrate for each receiver location enables optimization of transmission of data to each receiver location over a single channel.

6. A method according to claim 4 wherein the quality parameter relates to a picture quality for each of the plurality of receiver locations which is receiver location dependent.

7. A method according to claim 4 wherein information available at the transmitter and receiver location in a form selected from the group consisting of modulation and coding scheme, packet error rate (PER), number of automatic repeat requests (ARQs) or received signal strength (RSSI) is selectively used in determining the target transmit bitrate for a receiver location.

8. A method according to claim 1 wherein a rate-distortion model is used in determining the target transmit bitrates.

9. A method according to claim 1 wherein the video data is transmitted via a coaxial and/or fibre optic cabling network from the transmitter to the plurality of receiver locations.

10. A method according to claim 1 wherein the data stream includes multimedia data and control data; and the method further includes the steps of: extracting the control data from a first data stream to produce a multimedia data stream and a control data stream; and
transmitting the multimedia data stream to one or more receiver locations over a first channel and transmitting the control data stream to the one or more receiver locations over a second channel with the first channel being an in-band channel and the second channel an out-of-band channel.

11. A method according to claim 10 wherein the second channel is a session announcement protocol channel.

12. A method according to claim 10 wherein the control data stream includes transport stream data items relating to members of the group consisting of one or more of; program specific information, program association table information, program map table information, conditional access table information and network information table information.

13. A multi-channel data control and transmission system, said system comprising:
a plurality of video sources operable to output receptive video data streams;
a transmitter operable to receive video data streams from the video sources and operable to transmit such video data streams over transmission channels;
a plurality of receiver locations operable to receive the video data streams over respective transmission channels from the transmitter;
a transmit controller operable to estimate available channel capacity for each receiver location using parameters relating to members of the group consisting of a channel concerned, information available at the transmitter, or information relating to the queuing of video data between the video data sources and the transmitter, to determine a target transmit bitrate for each receiver location in dependence upon members selected from the group consisting of estimated channel capacity, a quality parameter, or an activity parameter for the receiver location and to control the video data sources and transmitter in dependence upon determined transmit bitrates.

14. A system according to claim 13 wherein the transmit controller allows dynamic optimization of the transmit bitrates employed by the video sources for transmission of the video data streams across the available channel.

15. A system according to claim 13 wherein the quality parameter for a receiver location relates to respective picture quality for that receiver location.

16. A system according to claim 13 wherein the transmit controller uses information in a form selected from the group consisting of modulation and coding scheme (MCS) mode, packet error rate (PER), number of automatic repeat requests (ARQs), or received signal strength (RSSI) to determine the target transmit bitrate for a receiver location.

17. A system according to claim 13 wherein the transmit controller includes a rate-distortion model which is used to determine the target bit transmit rates.

18. A system according to claim 13 wherein the system includes a coaxial and/or fibre optic data distribution network along which the data from the transmitter to the receiver location is carried.

19. A method of transmitting multimedia data from a transmitter to a plurality of receiver locations, the method comprising the following steps:
receiving a first data stream comprising multimedia data and control data;
extracting the control data from the first data stream to produce a multimedia data stream and a control data stream; and
transmitting the multimedia data stream to one or more receiver locations over a first channel and transmitting the control data stream to the one or more receiver locations over a second channel, wherein the first channel is an in-band channel, and the second channel is an out-of-band channel.

20. A method according to claim 19 wherein the control data stream includes data items relating to one or more members of the group consisting_of program specific information, program association table information, program map table information, conditional access table information, or network information table information.

21. A method according to claim 19 wherein the control data stream includes codec configuration data items in the form of one or more of encoder settings information, sequence parameter sets information, and picture parameter sets information.

22. Apparatus for transmitting multimedia data to one or more receiver locations, the apparatus comprising;
an input unit operable to receive a first data stream comprising multimedia data items and control data items;
an extraction unit operable to extract control data items from a first data stream to produce a multimedia data stream and a control data stream; and
a transmitter operable to transmit a multimedia data stream to a receiver location over a first channel, and to transmit a control data stream to that receiver location over a second channel different to the first channel, wherein the first channel is an in-band channel, and the second channel is an out-of-band channel.

23. Apparatus according to claim 22 wherein the apparatus includes a combining unit operable to combine a received multimedia data stream and the received control data stream, to produce an output stream.

24. Apparatus according to claim 22 wherein the apparatus is connected via a fibre optic and/or coaxial cable network system to allow the distribution of the data and services to different receiver locations within a single premises or series of premises.
